(19) United States
(12) Patent Application Publication
(10) Pub. No.: US 2015/0099682 A1
(43) Pub. Date: Apr. 9, 2015

(54) COMBINATION PRODUCT FOR WASHING AND CLEANING

(71) Applicant: Henkel AG & Co. KGaA, Duesseldorf (DE)

(72) Inventors: Nina Mussmann, Willich (DE); Thomas Eiting, Duesseldorf (DE); Thorsten Bastigkeit, Wuppertal (DE); Konstantin Benda, Duesseldorf (DE)

(21) Appl. No.: 14/569,993

(22) Filed: Dec. 15, 2014

Related U.S. Application Data
(63) Continuation of application No. PCT/EP2013/057335, filed on Apr. 9, 2013.

(30) Foreign Application Priority Data
Jun. 27, 2012 (DE) 10 2012 210 991.9

(51) Int. Cl. C11D 17/04; C11D 11/00; C11D 3/386

(52) U.S. Cl. CPC C11D 17/045; C11D 3/386; C11D 11/0023
USPC 510/224

(57) ABSTRACT

A higher stability of enzymes in flowable washing or cleaning agents is achieved if such products are offered as a combination product, which comprises a packaging means and at least two flowable washing or cleaning compositions A and B contained in said packaging means such that they are separated from one another, wherein the two compositions A and B contain A: —10 to 75 wt % builder(s); —0.1 to 10 wt % enzyme preparation; —24.9 to 89.9 wt % water; and B: —10 to 75 wt % builder(s); —less than 0.1 wt % enzyme preparation; —more than 24.9 wt % to 90 wt % water, and have a density difference of at least 2%, related to the lower density.

### FIELD OF THE INVENTION

The present invention generally relates to combination products for washing and cleaning, preferably for cleaning hard surfaces, and more particularly relates to combination products for automatic cleaning of dishes, and to a method for the use thereof.

### BACKGROUND OF THE INVENTION

Washing compositions and cleaning agents for hard surfaces, and also dishwashing agents, are available to consumers in a plurality of presentation forms. In addition to the traditional solid agents, flowable and in particular liquid to gel-type washing or cleaning agents have recently become increasingly important. In order to improve the cleaning performance of flowable washing or cleaning agents, the existing art has not only proposed the use of enzymes, but has also described combination products that comprise a packaging means and two flowable washing or cleaning agents separated from one another and present in said packaging means. International patent application WO 2007/025665, for example, discloses a packaging means and two flowable washing or cleaning agents A and B separated from one another and present in said packaging means, wherein composition A comprises enzymes and composition B comprises no enzymes or at least little enzyme. The physical separation of these two compositions make it possible to separate from the enzymes further ingredients and characteristics of washing or cleaning agents that might negatively affect the stability of those enzymes. As a rule the enzyme-containing composition A and the composition B containing no enzymes, or enzymes in only small quantities, therefore have different pH values. High pH values of, for example pH 10, 11, or higher destabilize or inactivate enzymes, but are advantageous for cleaning stubborn stains.

Whereas in the existing art the problem of destabilization of enzymes in the context of storage of a flowable washing or cleaning composition is solved by the aforementioned combination products, the problem of destabilization of enzymes in the context of the dispensing of said agents still exists. Regardless of whether dispensing occurs by means of a dispensing drawer of an automatic washing machine or a dispensing chamber of an automatic dishwasher or a dispensing ball or a further dispensing apparatus, the two phases mix with one another in the dispensing apparatus, thereby establishing an average pH that is lower than the pH of agent B but higher than that of agent A, so that the enzymes are therefore exposed to a higher pH than originally intended. Especially when the automatic washing or cleaning operation is started not directly but only after a time delay, the risk of destabilizing the enzymes exists.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A combination product comprising a packaging means and at least two flowable washing or cleaning compositions A and B separated from one another and present in said packaging means, wherein the compositions A and B contain:
A: 10 to 75 wt % builder(s); 0.1 to 10 wt % enzyme preparation; 24.9 to 89.9 wt % water; and B: 10 to 75 wt % builder(s); less than 0.1 wt % enzyme preparation; more than 24.9 wt % to 90 wt % water, preferably 25 to 90 wt % water; characterized in that the two compositions A and B have a density difference of at least 2%, based on the lower density.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

To achieve the object of the present invention, combination products are proposed which comprise a packaging means and two flowable washing or cleaning compositions A and B separated from one another and present in said packaging means, wherein composition A contains 10 to 75 wt % builder(s), 0.1 to 10 wt % enzyme preparation, and 24.9 to 89.9 wt % water, and composition B contains 10 to 75 wt % builder(s), less than 0.1 wt % enzyme preparation, and more than 24.9 wt % to 90 wt % water, preferably 25 to 90 wt % water, wherein the two compositions A and B have a density difference of at least 2%, based on the lower density. It is immaterial in this context whether composition A or composition B has the higher density. No particular requirements are imposed regarding the upper limit of the density, except for the one that the composition having the higher density must remain flowable under utilization conditions.

The combination products according to the present invention furthermore comprise, besides the two liquid cleaning compositions A and B, a packaging means. The two cleaning compositions A and B are present separately from one another in this packaging means, i.e. they do not form a common phase boundary but instead are located in regions of the packaging means that are separated from one another, for example by a partition.

A water-insoluble two- or multi-chamber container is suitable, for example, as such a packaging means. A two- or multi-chamber container of this kind has, not obligatorily but typically, a total volume of between 100 and 5000 ml, preferably between 200 and 2000 ml. The volume of the individual chambers is preferably between 50 and 2000 ml, preferably between 100 and 1000 ml. Preferred two- or multi-chamber containers are bottle-shaped.

For dispensing the liquid washing or cleaning agent, the two- or multi-chamber container preferably possesses at least one spout, which can be configured, for example, in the form of a shared spout for all the compositions contained in the bottle. Those two- or multi-chamber containers in which each of the receiving chambers of the container possesses its own spout are, however, preferred. Such a configuration, for example, avoids contamination of individual chambers with ingredients from another chamber.

Combination products according to the present invention in which the packaging means is a water-insoluble two- or multi-chamber container, wherein preferably each of the receiving chambers of the packaging means is equipped with a spout, are preferred.

Dispensing of the two flowable washing or cleaning compositions A and B can occur in the case of a washing agent, for example, via a dispensing drawer of the washing machine or via a separate dispensing apparatus such as a dispensing ball that is placed directly into the washing drum. In the case of an automatic dishwashing product dispensing can occur, for example, into the dispensing chamber in the door or into an additional dispensing container in the interior of the automatic dishwasher or directly onto the soiled dishes. Alternatively, the two washing or cleaning agents can also be dispensed onto one of the inner walls of the automatic dishwasher, for example onto the inside of the door.

The washing or cleaning compositions A and B must be flowable under utilization conditions. This is understood to mean that compositions A and B can be dispensed without further aids out of the packaging means into the intended machine or dispensing apparatus. If the packaging means is made of a flexible material, compositions A and/or B can also exhibit a rheological behavior such that they are not flowable in the rest state in the packaging means but can be converted into a flowable state, and thus dispensed, by means of gentle pressure by the user on the packaging means, or by shaking,. As a rule these are liquid agents that are flowable under normal utilization conditions, and whose viscosities can vary over a wide range. Gel-type or pasty agents are also included among the liquid preparations in the context of the present invention. In a further preferred embodiment of the invention, the liquid compositions are water-based.

The density difference between the two washing or cleaning compositions A and B is preferably at least 5% and can be up to 60%, based in each case on the lower density, or even greater. Greater density differences can result in disadvantages in terms of flowability and dispensing accuracy, however, and are therefore less preferred. A particularly preferred density difference, based in each case on the lower density, is 7% to 40%, very particularly preferably 8% to 20%. Embodiments in which composition A has a lower density than composition B are preferred. In a further preferred embodiment of the invention, the density of composition A upon dispensing is 1.00 to 1.40 g/ml, preferably 1.15 to 1.30 g/ml. In a further preferred embodiment of the invention, the density of composition B upon dispensing is 1.20 to 1.60 g/ml and preferably 1.25 to 1.40 g/ml.

The density of compositions A and B, and thus also the density difference between agents A and B, can be adjusted in a variety of ways familiar to one skilled in the art. One possibility is to add to the agent having the higher density a thickening agent, or a thickening agent in higher quantities than to the agent having the lower density. The addition of thickening agents results not only in an elevated viscosity of the flowable agent, but as a rule also in an elevated density.

Polymeric thickening agents for purposes of the present invention are polycarboxylates having a thickening effect as polyelectrolytes, preferably homo- and copolymerizates of acrylic acid, in particular acrylic acid copolymers such as acrylic acid/methacrylic acid copolymers, and polysaccharides, in particular heteropolysaccharides, as well as other usual thickening polymers.

Thickening polyacrylates, which are obtainable e.g. under the commercial name Carbopol®, or known thickening agents based on starch or cellulose, are particularly preferred.

The polymeric thickening agent content is preferably 0.1 to 5 wt % and in particular 0.5 to 3 wt %, based in each case on the sum of compositions A and B.

Another possibility, which can also be used in combination with a thickening agent, consists in varying the quantities of specific solid raw materials in compositions A and B, while the total quantity of those raw materials in the combination product according to the present invention remains the same. Useful in this context, for example, are builders that are added in solid form upon manufacture of the compositions. In phosphate-containing compositions, for example, different quantities of phosphate can be used for this purpose. In phosphate-containing compositions, the concentration of thickening agents is preferably 0.5 to 15 wt %, based both on the respective composition and on the sum of compositions A and B.

It has proven advantageous in use if composition A, which is characterized by the higher enzyme content, has a lower density than composition B.

Preferred combination products of the present invention comprise flowable, in particular liquid to gel-type cleaning agents that are suitable for use in automatic dishwashers.

The liquid cleaning compositions A and B present separately from one another in the combination products according to the present invention contain builders in addition to further ingredients having washing or cleaning activity. Included among the builders are in particular zeolites, silicates, carbonates, organic co-builders, and—provided no environmental prejudices against their use exist—also phosphates.

Appropriate silicates are amorphous sodium silicates having a Na₂O:SiO₂ modulus from 1:2 to 1:3.3, preferably from 1:2 to 1:2.8, and in particular from 1:2 to 1:2.6, but also crystalline sheet silicates of the general formula NaMSiₓO₂ₓ₊₁·y H₂O, in which M represents sodium or hydrogen, x is a number from 1.9 to 22, preferably from 1.9 to 4, wherein particularly preferred values for x are 2, 3, or 4, and y denotes a number from 0 to 33, preferably from 0 to 20.

It is preferred in the context of the present invention for this/these silicate(s), preferably alkali silicates, particularly preferably crystalline or amorphous alkali disilicates, to be contained in the liquid cleaning compositions A and/or B in quantities from 2 to 40 wt %, preferably from 3 to 30 wt %, and in particular from 5 to 25 wt %, based in each case on the weight of the respective cleaning composition A or B.

In much of the world, phosphates are still being used today in preferred fashion in automatic dishwashing agents. Among the plurality of commercially obtainable phosphates, the alkali-metal phosphates have the greatest significance in the washing- and cleaning-agent industry, with particular preference for pentasodium or pentapotassium triphosphate (sodium or potassium tripolyphosphate).

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates embody a combination of advantages: they act as alkali carriers, prevent lime deposits on machine parts or lime incrustations in fabrics, and furthermore contribute to cleaning performance.

If phosphates are employed in the context of the present Application in the liquid cleaning compositions A and/or B as substances having washing or cleaning activity, preferred combination products then contain that/those phosphate(s), preferably alkali-metal phosphate(s), particularly preferably pentasodium and/or pentapotassium triphosphate (sodium and/or potassium tripolyphosphate), in quantities from 5 wt % to 60 wt %, preferably from 8 wt % to 45 wt %, and in particular from 10 wt % to 40 wt %, based in each case on the weight of the respective cleaning composition A or B. In a preferred embodiment of the invention composition A has less phosphate than composition B. In a further preferred embodiment composition A has phosphates in quantities from 5 to 15 wt % based on composition A, and composition B from 10 to 20 wt % based on composition B, with the provision that the phosphate quantity in composition B is higher than in composition A.

Organic co-builders that are to be recited are in particular polycarboxylates/polycarboxylic acids, polymeric polycarboxylates, aspartic acid, polyacetals, dextrins, further organic co-builders, as well as phosphonates.

Usable organic builder substances are, for example, polycarboxylic acids, which can be used in the form of the free acid and/or sodium salts thereof, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess the property of an acidifying component in addition to their builder effect, and thus also serve to establish a lower and milder pH for washing or cleaning agents. Worthy of mention in this context are, in particular, citric acid, succinic acid, glutaric acid, adipic acid, gluconic acid, and any mixtures thereof.

A further significant class of phosphate-free builders is represented by aminocarboxylic acid and/or salts thereof. Particularly preferred representatives of this class are methylglycinediacetic acid (MGDA) or salts thereof, as well as glutaminediacetic acid (GLDA) or salts thereof. The concentration of these aminocarboxylic acids or salts thereof can constitute, for example, between 0.1 and 15 wt %, based on the sum of compositions A and B.

Also suitable as builders are polymeric polycarboxylates, which are e.g. the alkali-metal salts of polyacrylic acid or of polymethacrylic acid, for example those having a relative molecular weight from 500 to 70,000 g/mol.

The combination products according to the present invention contain enzymes as a further constituent in order to increase the washing or cleaning performance. These include in particular proteases, amylases, lipases, cutinases, cellulases, hemicellulases, included among which are also mannanases, xanthan lyases, pectin lyases (=pectinases), pectin esterases, pectate lyases, xyloglucanases (=xylanases), pullulanases, and β-glucanases or oxidoreductases, as well as preferably mixtures thereof. These enzymes are in principle of natural origin; proceeding from the natural molecules, improved variants are available for use in washing or cleaning agents and are used in correspondingly preferred fashion. Washing or cleaning agents contain enzymes preferably in total quantities from 1×10⁻⁶ to 5 wt %, based on active protein. The protein concentration can be determined with the aid of known methods, for example the BCA method or the biuret method.

Among the proteases, those of the subtilisin type are preferred. Examples of usable amylases are the α-amylases from Bacillus licheniformis, from B. amyloliquefaciens, from B. stearothermophilus, from Aspergillus niger and A. oryzae, and the further developments of the aforementioned amylases improved for use in washing and cleaning agents. Additionally to be highlighted for this purpose are the α-amylase from Bacillus sp. A 7-7 (DSM 12368) and the cyclodextrin-glucanotransferase (CGTase) from B. agaradherens (DSM 9948).

The enzymes can be employed in any form established according to the existing art (a so-called “enzyme preparation”). These include, for example, the solid preparations obtained by granulation, extrusion, encapsulation, or freeze-drying, or (in particular with liquid or gel-type agents) solutions of the enzymes, which advantageously are maximally concentrated, low in water, and/or have stabilizers added. In the context of the present invention, “enzyme” or “enzymes” are understood as a corresponding enzyme preparation unless it is unequivocally specified that the active protein is meant.

It is furthermore possible to formulate two or more enzymes together so that a single granulate or a single enzyme preparation exhibits multiple enzyme activities.

As stated earlier, the weight proportion of enzymes in terms of the total weight of the flowable cleaning composition A is 0.1 to 10 wt %, advantageously 0.2 to 9 wt %, and in particular 0.5 to 8 wt %. Particularly good cleaning performance is achieved when the weight proportion of enzyme in terms of the total weight of cleaning composition A is 1 to 5 wt %.

Although the flowable cleaning composition B can of course also contain enzymes, it is nevertheless preferred that the enzyme content of cleaning composition B be as low as possible, and in particular less than 0.1 wt %. Particularly preferred combination products are characterized in that the flowable cleaning composition B contains no enzymes, and that the entire quantity of enzyme is furnished by way of the flowable cleaning composition A.

Preferably one or more enzymes and/or enzyme preparations, preferably solid or liquid protease preparations ad/or amylase preparations, are employed. In a preferred embodiment of the invention the liquid composition A comprises an enzyme preparation that contains amylase. In a particularly preferred embodiment the liquid composition A comprises a combination of a protease preparation and amylase preparation. The quantities of enzyme preparations in composition A are advantageously between 1 and 10 wt %, based on composition A.

The combination products according to the present invention can also contain enzyme stabilizers. One group of stabilizers is reversible protease inhibitors. Benzamidine hydrochloride, borax, boric acids, boronic acids, or salts or esters thereof, are often employed for this, among them principally derivatives having aromatic groups, e.g. ortho-, meta-, or para-substituted phenylboronic acids, in particular 4-formylphenylboronic acid, or the respective salts or esters of the aforesaid compounds. Peptide aldehydes, i.e. oligopeptides having a reduced C-terminus, in particular those made up of 2 to 50 monomers, are also used for this purpose. Ovomucoid and leupeptin, among others, are among the peptide-type reversible protease inhibitors. Specific reversible peptide inhibitors for the subtilisin protease, as well as fusion proteins of proteases and specific protease inhibitors, are also used for this.

Further enzyme stabilizers are aminoalcohols such as mono-, di-, triethanol- and -propanolamine and mixtures thereof, aliphatic carboxylic acids up to C₁₂ such as succinic acid, other dicarboxylic acids or salts of the aforesaid acids. End-capped fatty acid amide alkoxylates are also suitable for this purpose. As disclosed in WO 97/18287, specific organic acids employed as builders are additionally capable of stabilizing a contained enzyme.

Further enzyme stabilizers are known to the skilled artisan from the existing art.

It is particularly preferred to use combinations of stabilizers, for example made up of polyols such as glycerol, ethylene glycol, propylene glycol, or sorbitol, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is favorably enhanced by combination with boric acid and/or boric acid derivatives and polyols, and even further by the additional effect of divalent cations such as calcium ions.

The agents according to the present invention described previously can contain, besides the ingredients described previously, further substances having washing and cleaning activity, preferably substances having washing and cleaning activity from the group of surfactants, polymers, glass corrosion inhibitors, corrosion inhibitors, alkali carriers, scents and perfume carriers, dyes, and preservatives. Bleaching agents and bleach activators, in particular liquid bleach activators, can likewise be present. These preferred ingredients will be described in further detail below.

Nonionic, anionic, cationic, and amphoteric surfactants are included in the group of surfactants.

Included among the anionic surfactants are those having at least one sulfate group or sulfonate group, preferably selected from fatty alcohol sulfates, ether sulfates, alkanesulfonates, and alkylbenzenesulfonates. Preferred in this context are C₁₂ to C₁₈ fatty alcohol sulfates, e.g. Sulfopon K 35 (BASF, Germany), ethoxylated C₁₂ to C₁₄ alcohol sulfates, e.g. Texapon N70 (BASF, Germany), secondary C₁₃ to C₁₇ alkanesulfonates, e.g. Hostapur SAS 93 (Clariant, Germany), and linear C₈ to C₁₈ alkylbenzenesulfonates, in particular dodecylbenzenesulfonate or C₉ to C₁₃ alkylbenzenesulfonate.

All nonionic surfactants known to one skilled in the art can be used as nonionic surfactants. These include, for example, ethoxylated and/or propoxylated alcohols or fatty alcohols, as well as nonionic surfactants of the amine oxide type, for example N-cocalkyl-N,N-dimethylamine oxide and N-tallowalkyl-N,N-dihydroxyethylamine oxide, and fatty acid alkanolamides.

Nonionic surfactants from the group of alkoxylated alcohols, in particular alkoxylated linear C₈ to C₁₈ alcohols, or methyl-branched straight-chain or non-straight-chain alcohols, particularly preferably from the group of mixed alkoxylated alcohols and in particular from the group of EO-AO-EO nonionic surfactants, are used with particular preference.

Low-foaming nonionic surfactants that comprise alternative ethylene-oxide and alkylene-oxide units have proven to be particularly preferred nonionic surfactants in the context of the present invention. Among these, surfactants having EO-AO-EO-AO blocks are in turn preferred, wherein one to ten EO or AO groups are connected to one another before a block of the other group follows. Nonionic surfactants of the general formula

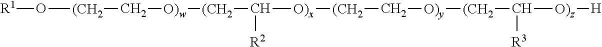

in which R¹ denotes a straight-chain or branched, saturated or mono- or polyunsaturated C₆₋₂₄ alkyl residue or alkenyl residue are preferred; each group R² or R³ is selected mutually independently from —CH₃, —CH₂CH₃, —CH₂CH₂—CH₃, CH(CH₃)₂, and the indices w, x, y, z mutually independently denote integers from 1 to 6.

Particularly preferred nonionic surfactants are therefore those which comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and are usable with particular preference according to the present invention.

Surfactants of the general formula

R¹—CH(OH)CH₂O-(AO)_{w}-(A′O)ₓ-(A″O)_{y}-(A′″O)_{z}—R², in which

R¹ and R² mutually independently denote a straight-chain or branched, saturated or mono- or polyunsaturated C₂₋₄₀ alkyl or alkenyl residue; A, A′, A″ and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z denote values between 0.5 and 90, wherein x, y and/or z can also be 0, are particularly preferred according to the invention.

Very particularly preferred nonionic surfactants exhibit, in a preferred embodiment, the general formula

R¹O[CH₂CH(CH₃)O]ₓ[CH₂CH₂O]_{y}[CH₂CH(CH₃)O]_{z}CH₂CH(OH)R²,

in which R¹ denotes a linear or branched aliphatic hydrocarbon residue having 4 to 22 carbon atoms, or mixtures thereof, R² denotes a linear or branched hydrocarbon residue having 2 to 26 carbon atoms, in particular 4 to 20 carbon atoms, or mixtures thereof, and x and z denote values between 0 and 40 and y denotes a value of at least 15.

The addition of these nonionic surfactants has proven advantageous in particular in terms of rinsing performance and drying. In a preferred embodiment the automatic dishwashing agent contains, based on the sum of compositions A and B, nonionic surfactant of the general formula

R¹O[CH₂CH(CH₃)O]ₓ[CH₂CH₂O]_{y}[CH₂CH(CH₃)O]_{z}CH₂CH(OH)R²

in quantities from 0.1 to 15 wt %, preferably 0.2 to 10 wt %, particularly preferably 0.5 to 8 wt %, and in particular from 1.0 to 6 wt %.

Particularly preferred are those end-capped poly(oxyalkylated) nonionic surfactants according to the formula R¹O[CH₂CH₂O]_{y}CH₂CH(OH)R² in which R¹ denotes a linear or branched aliphatic hydrocarbon residue having 4 to 22, in particular 6 to 16 carbon atoms, or mixtures thereof, R² denotes a linear or branched hydrocarbon residue having 2 to 26, in particular 4 to 20 carbon atoms, or mixtures thereof, and y denotes a value between 15 and 120, preferably 20 to 100, in particular 20 to 80. Members of this group of nonionic surfactants include, for example, hydroxy mixed ethers of the general formula C₆₋₂₂—CH(OH)CH₂O-(EO)₂₀₋₁₂₀-C₂₋₂₆, for example C₈₋₁₂ fatty alcohol-(EO)₂₂-2-hydroxydecyl ethers and C₄₋₂₂ fatty alcohol-(EO)₄₀₋₈₀-2-hydroxyalkyl ethers.

A surfactant of the general formula R¹CH(OH)CH₂O—(CH₂CH₂O)₂₀₋₁₂₀-R², wherein R¹ and R² mutually independently denote a linear or branched aliphatic hydrocarbon residue having 2 to 20 carbon atoms, is particularly preferred as a further nonionic surfactant.

Also preferred are surfactants of the formula R¹O[CH₂CH(CH₃)O]ₓ[CH₂CH₂O]_{y}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x denotes values between 0.5 and 4, preferably 0.5 to 15, and y denotes a value of at least 15.

Also preferred are surfactants of the general formula R¹O[CH₂CH(CH₃)O]ₓ[CH₂CH₂O]_{y}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x denotes a value between 1 and 40 and y denotes a value between 15 and 40, wherein the alkylene units [CH₂CH(CH₃)O] and [CH₂CH₂O] are present in randomized fashion, i.e. in the form of a statistical, random distribution.

Also belonging to the group of the preferred end-capped poly(oxyalkylated) nonionic surfactants are nonionic surfactants of the formula R¹O[CH₂CH₂O]ₓ[CH₂CH(R³)O]_{y}CH₂CH(OH)R² in which R¹ and R² mutually independently denote a linear or branched, saturated or mono- or polyunsaturated hydrocarbon residue having 2 to 26 carbon atoms, R³ is selected mutually independently from —CH₃, —CH₂CH₃, —CH₂CH₂—CH₃, —CH(CH₃)₂, but preferably denotes —CH₃, and x and y mutually independently denote values between 1 and 32, wherein nonionic surfactants where R³═—CH₃ and having values for x from 15 to 32 and for y from 0.5 to 1.5 are very particularly preferred.

Further nonionic surfactants preferred for use are the end-capped poly(oxyalkylated) nonionic surfactants of the formula

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon residues having 1 to 30 carbon atoms, R³ denotes hydrogen or a methyl, ethyl, n-propyl, isopropyl, n-butyl, 2-butyl, or 2-methyl-2-butyl residue, x denotes values between 1 and 30, k and j denote values between 1 and 12, preferably between 1 and 5. If the value of x is ≧2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon residues having 6 to 22 carbon atoms, residues having 8 to 18 carbon atoms being particularly preferred. Hydrogen, —CH₃, or —CH₂CH₃ are particularly preferred for the residue R³. Particularly preferred values for x are in the range from 1 to 20, in particular from 6 to 15.

As described above, each R³ in the above formula can be different if x≧2. The alkylene oxide unit in square brackets can thereby be varied. If x denotes 3, for example, the residue R³ can be selected in order to form ethylene oxide units (R³═H) or propylene oxide units (R³═CH₃), which can be fitted together in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected here by way of example, and can certainly be greater; the range of variation increases with rising values of x and includes, for example, a large number of (EO) groups combined with a small number of (PO) groups, or vice versa.

Particularly preferred end-capped poly(oxyalkylated) alcohols of the above formula have values k=1 and j=1, so that the formula above becomes simplified to

R¹O[CH₂CH(R³)O]ₓCH₂CH(OH)CH₂OR².

In the latter formula, R¹, R², and R³ are as defined above and x denotes numbers from 1 to 30, preferably from 1 to 20, and in particular from 6 to 18. Surfactants in which the residues R¹ and R² have 9 to 14 carbon atoms, R³ denotes hydrogen, and x assumes values from 6 to 15, are particularly preferred.

Further nonionic surfactants that are preferably used are nonionic surfactants of the general formula R¹O(AlkO)ₓM(OAlk)_{y}OR², wherein

R¹ and R² mutually independently denote a branched or unbranched, saturated or unsaturated, optionally hydroxylated alkyl residue having 4 to 22 carbon atoms;

Alk denotes a branched or unbranched alkyl residue having 2 to 4 carbon atoms;

x and y mutually independently denote values between 1 and 70; and

M denotes an alkyl residue from the group CH₂, CHR³, CR³R⁴, CH₂CHR³, and CHR³CHR⁴, where R³ and R⁴ mutually independently denote a branched or unbranched, saturated or unsaturated alkyl residue having 1 to 18 carbon atoms.

Preferred in this context are nonionic surfactants of the general formula

R¹—CH(OH)CH₂—O(CH₂CH₂O)ₓCH₂CHR(OCH₂CH₂)_{y}O—CH₂CH(OH)—R², wherein
R, R¹, and R² mutually independently denote an alkyl residue or alkenyl residue having 6 to 22 carbon atoms;
x and y mutually independently denote values between 1 and 40.

Particularly preferred in this context are compounds of the general formula R¹—CH(OH)CH₂—O(CH₂CH₂O)ₓCH₂CHR(OCH₂CH₂)_{y}O—CH₂CH(OH)—R² in which R denotes a linear, saturated alkyl residue having 8 to 16 carbon atoms, preferably 10 to 14 carbon atoms, and n and m mutually independently have values from 20 to 30. Corresponding compounds can be obtained, for example, by reacting alkyl diols HO—CHR—CH₂—OH with ethylene oxide followed by reaction with an alkyl epoxide in order to close off the free OH functions, forming a dihydroxy ether.

In a further preferred embodiment the nonionic surfactant is selected from nonionic surfactants of the general formula

R¹—O(CH₂CH₂O)ₓCR³R⁴(OCH₂CH₂)_{y}O—R² in which
R¹ and R² mutually independently denote an alkyl residue or alkenyl residue having 4 to 22 carbon atoms;
R³ and R⁴ mutually independently denote hydrogen or an alkyl residue or alkenyl residue having 1 to 18 carbon atoms; and
x and y mutually independent denote values between 1 and 40.

Compounds of the general formula R¹—O(CH₂CH₂O)ₓCR³R⁴(OCH₂CH₂)_{y}O—R², in which R³ and R⁴ denote hydrogen and the indices x and y mutually independently assume values from 1 to 40, preferably from 1 to 15, are preferred here in particular.

In particular, compounds of the general formula R¹O(CH₂CH₂O)ₓCR³R⁴(OCH₂CH₂)_{y}O—R² in which the residues R¹ and R² mutually independently represent saturated alkyl residues having 4 to 14 carbon atoms, and the indices x and y mutually independently assume values from 1 to 15 and in particular from 1 to 12, are particularly preferred.

Also preferred are those compounds of the general formula R¹—O(CH₂CH₂O)ₓCR³R⁴(OCH₂CH₂)_{y}O—R² in which one of the residues R¹ and R² is branched.

Compounds of the general formula R¹—O(CH₂CH₂O)ₓCR³R⁴(OCH₂CH₂)_{y}O—R² in which the indices x and y mutually independently assume values from 8 to 12 are very particularly preferred.

The carbon chain lengths, and degrees of ethoxylation or alkoxylation, indicated for the aforesaid nonionic surfactants represent statistical averages that can be an integer or a fractional number for a specific product. As a result of the manufacturing method, commercial products of the formulas recited are usually made up not of an individual representative but rather of mixtures, which can result in averages and, as a consequence thereof, fractional numbers for both the carbon chain lengths and the degrees of ethoxylation or alkoxylation.

The aforesaid nonionic surfactants can of course be employed not only as individual substances but also as surfactant mixtures of two, three, four, or more surfactants. “Surfactant mixtures” refers not to mixtures of nonionic surfactants that are embraced in their totality by one of the aforesaid general formulas, but instead to those mixtures which contain two, three, four, or more nonionic surfactants that can be described by different ones of the aforesaid general formulas.

Utilization of the above-described nonionic surfactants having a free hydroxyl group on one of the two terminal alkyl residues allows rinsing performance and drying to be appreciably improved as compared with conventional polyalkoxylated fatty alcohols having no free hydroxyl group.

In a preferred embodiment the nonionic surfactant content, based on the sum of compositions A and B, is 0.1 to 20 wt %, particularly preferably 0.5 to 15 wt %, in particular 2 to 10 wt %.

Preferred embodiments of the present invention contain as a further constituent at least one anionic polymer. Preferred anionic polymers in this context are copolymeric polycarboxylates and copolymeric polysulfonates (sulfopolymers). Mixtures of these polymers can also be employed.

In a preferred embodiment the weight proportion of anionic polymer, based on the sum of compositions A and B, is from 0.1 to 20 wt %, preferably from 0.5 to 18 wt %, particularly preferably from 1.0 to 15 wt %, and in particular from 4 to 14 wt %.

A particularly preferred subject of the present invention comprises one or more copolymeric anionic polymers that are selected from the group of hydrophobically modified polycarboxylates and the sulfopolymers. An improvement in the rinsing and drying properties of said agents, simultaneously with decreased deposit formation, can be achieved by means of such a mixture of anionic copolymers.

The copolymers can comprise two, three, four or more different monomer units.

Preferred copolymeric polysulfonates contain, besides sulfonic-acid-group-containing monomer(s), at least one monomer from the group of unsaturated carboxylic acids.

Unsaturated carboxylic acid(s) used with particular preference are unsaturated carboxylic acids of the formula R¹(R²)C═C(R³)COOH in which R¹ to R³ mutually independently denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, α-chloroacrylic acid, α□cyanoacrylic acid, crotonic acid, □α-phenylacrylic acid, maleic acid, maleic acid anhydride, fumaric acid, itaconic acid, citraconic acid, methylenemalonic acid, sorbic acid, cinnamic acid, or mixtures thereof.

In the context of the sulfonic-acid-group-containing monomers, those of the formula

R⁵(R⁶)C═C(R⁷)—X—SO₃H,

in which R⁵ to R⁷ mutually independently denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₃)—CH₂—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H,

in which R⁶ and R⁷ are selected mutually independently from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₃)—CH₂—, are preferred.

Particularly preferred sulfonic-acid-group-containing monomers in this context are 1-acrylamido-1 -propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide, and mixtures of the aforesaid acids or water-soluble salts thereof.

The sulfonic acid groups can be present in the polymers entirely or partly in neutralized form, i.e. the acid hydrogen atom of the sulfonic acid group can be replaced, in some or all of the sulfonic acid groups, with metal ions, preferably alkali-metal ions, and in particular with sodium ions. The use of partly or entirely neutralized sulfonic-acid-group-containing copolymers is preferred according to the present invention.

In the context of copolymers that contain only carboxylic-acid-group-containing monomers and sulfonic-acid-group-containing monomers, the monomer distribution of the copolymers preferably used according to the present invention is preferably 5 to 95 wt %; particularly preferably, the proportion of the sulfonic-acid-group-containing monomer is 50 to 90 wt % and the proportion of the carboxylic-acid-group-containing monomer is 10 to 50 wt %, the monomers preferably being selected from those recited above.

The molar mass of the sulfo-copolymers preferably used according to the present invention can be varied in order to adapt the properties of the polymers to the desired application. Preferred automatic dishwashing agents are characterized in that the copolymers have molar masses from 2000 to 200,000 gmol⁻¹, preferably from 4000 to 25,000 gmol⁻¹, and in particular from 5000 to 15,000 gmol⁻¹.

In a further preferred embodiment the copolymers also comprise, besides carboxyl-group-containing monomers and sulfonic-acid-group-containing monomers, at least one nonionic, preferably hydrophobic monomer. The use of these hydrophobically modified polymers has made it possible in particular to improve the rinsing performance of automatic dishwashing agents according to the present invention.

In a further preferred embodiment of the invention the agents contain at least one anionic copolymer comprising

i) carboxylic-acid-group-containing monomer(s),

ii) sulfonic-acid-group-containing monomer(s),

iii) nonionic monomer(s).

The nonionic monomers used are preferably monomers of the general formula R¹(R²)C═C(R³)—X—R⁴, in which R¹ to R³ mutually independently denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, α-olefins having 10 or more carbon atoms, for example 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

In a further preferred embodiment of the invention composition A contains 1 to 10 wt %, in particular 2 to 8 wt % sulfopolymer. Composition B can contain sulfopolymer; the weight proportion of sulfopolymer can in fact be higher in composition B than in composition A. Because it has been found that the distribution of the sulfopolymer has a large influence on the density of compositions A and B, it is left to the skilled artisan to distribute the total quantity of sulfopolymer in accordance with how he or she wishes to adjust the density of compositions A and B.

Combination products in which the weight proportion of sulfopolymer in composition A is higher than the weight proportion of sulfopolymer in composition B are preferred, the density of composition A being lower than the density of composition B.

Cationic or amphoteric polymers can also be suitable. Included thereamong are, for example, copolymers of diallylammonium salts and acrylamides, quaternized vinylpyrrolidone/vinylimidazole polymers, for example Luviquat® (BASF), condensation products of polyglycols and amines, polyethyleneimine, copolymers of acrylic acid with dimethyldiallylammonium chloride (Merquat® 550/Chemviron), polyaminopolyamides and crosslinked water-soluble polymers thereof, quaternized ammonium salt polymers. Amphoteric polymers such as those described in applications WO 2012/107554 and WO 2012/000629 are particularly preferred. These are polymers containing
a) at least one monomer according to the formula

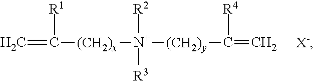

wherein

R₁ and R₄ mutually independently denote hydrogen or C₁₋₆ alkyl;

R₂ and R₃ mutually independently denote C₁₋₆ alkyl, hydroxy-C₁₋₆ alkyl, or amino-C₁₋₆ alkyl;

m and n mutually independently denote a value from 1 to 3;

X⁻ denotes a counter ion;
b) at least one hydrophilic monomer that carries at least one acid group;
c) at least one hydrophilic nonionic monomer.

“Alkali carriers” are considered to be, for example, hydroxides, preferably alkali-metal hydroxides, carbonates, hydrogen carbonates, or sesquicarbonates, preferably alkali-metal carbonates or alkali-metal hydrogen carbonates or alkali-metal sesquicarbonates, wherein the alkali-metal hydroxides and alkali carbonates, in particular sodium hydroxide, potassium hydroxides, sodium carbonate, sodium hydrogen carbonate, or sodium sesquicarbonate are preferably employed for purposes of this invention.

It has been found that the performance of the cleaning agents can be improved by means of organic solvents. These organic solvents derive, for example, from the groups of monoalcohols, diols, triols or polyols, ethers, esters, and/or amides. Particularly preferred in this context are organic solvents that are water-soluble, wherein “water-soluble” solvents for purposes of the present application are solvents that at room temperature are completely miscible with water, i.e. without mixing gaps.

Organic solvents that can be employed in the agents according to the present invention preferably derive from the group of mono- or polyvalent alcohols, alkanolamines, or glycol ethers, provided they are miscible with water in the concentration range indicated. The solvents are preferably selected from ethanol, n- or isopropanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, or propylene glycol propyl ether, dipropylene glycol methyl ether or dipropylene glycol ethyl ether, methoxytriglycol, ethoxytriglycol, or butoxytriglycol, 1-butoxyethoxy-2-propanol, 3-methyl-3-methoxybutanol, propylene glycol t-butyl ether, and mixtures of said solvents.

Organic solvents from the group of organic amines and/or alkanolamines have proven to be particularly effective in terms of cleaning performance, and in that context in turn with regard to cleaning performance on bleachable stains, in particular on tea stains.

Preferred dyes, the selection of which will present no difficulty whatsoever to the skilled artisan, possess excellent shelf stability and insensitivity to the other ingredients of the agents and to light, and no pronounced substantivity with respect to the substrates, for example textiles, glass, ceramic, or plastic dishes, to be treated with the dye-containing agents, in order not to color them.

Preservatives can furthermore be contained in the agents. Preservatives from the groups of alcohols, aldehydes, antimicrobial acids or salts thereof, carboxylic acid esters, acid amides, phenols, phenol derivatives, diphenyls, diphenylalkanes, urea derivatives, oxygen and nitrogen acetals and oxygen and nitrogen formals, benzamidines, isothiazoles and derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-1,4-dicyanobutane, iodo-2-propynyl butylcarbamate, iodine, iodophores, and peroxides, are suitable, for example. Preferred antimicrobial active agents are preferably selected from the group comprising ethanol, n-propanol, isopropanol, 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyldi-1-pyridinyl-4-ylidene)-bis-(1-octanamine)dihydrochloride, N,N′-bis-(4-chlorophenyl)-3,12-diimino-2,4,11,13-tetraazatetradecanediimideamide, antimicrobial quaternary surface-active compounds, guanidines. Particularly preferred preservatives are selected, however, from the group comprising salicylic acid, quaternary surfactants, in particular benzalkonium chloride, and isothiazoles and derivatives thereof such as isothiazolines and isothiazolinones.

Phosphonates can be employed as complexing agents. It has been found that the phosphonates also have an influence on the density of the compositions. In a further embodiment of the invention, combination products in which the weight proportion of phosphonate in composition A is less than the weight proportion of phosphonate in composition B, and at the same time the density of composition A is lower than the density of composition B, are therefore preferred. It has proven to be particularly advantageous if compositions A are free of phosphonates, while compositions B contain phosphonates.

The pH at 20° C. of compositions A and B is within usual ranges. The enzyme-containing composition A preferably has a pH (20° C.) of between 6 and 9, while composition B has a pH (20° C.) of between 9 and 14.

In a further embodiment of the invention an automatic washing- or cleaning-agent method, in particular an automatic dishwashing agent method, is claimed, wherein from a combination product according to the present invention comprising a packaging means and at least two flowable washing or cleaning compositions A and B separated from one another and present in said packaging means, dispensing occurs into a dispensing apparatus provided in the machine or into a separate dispensing apparatus or directly into the machine, and the washing or cleaning operation is then initiated. The two compositions A and B have the following compositions:
A: 10 to 75 wt % builder(s);

0.1 to 10 wt % enzyme preparation;

24.9 to 89.9 wt % water, and
B: 10 to 75 wt % builder(s);

less than 0.1 wt % enzyme preparation;

more than 24.9 wt % to 90 wt % water, preferably 25 to 90 wt % water,

and exhibit a density difference of at least 2%, preferably of at least 5%, based in each case on the lower density.

### EXAMPLE

19.3 g each of compositions A and B of products 1 (inventive) and 2 (comparison) were tested, on the one hand directly after manufacture and on the other hand after 18 hours of incubation at room temperature, in the main washing cycle of a Miele G698SC dishwasher (50° C. program; water at 21° dH water hardness) under IKW standard conditions. Whereas an appreciable deterioration in amylase performance was observable with comparison product 2 after only 18 hours, the inventive product 1 produced approximately the same cleaning results as the fresh product even after 18 hours of incubation.

TABLE 1
Composition A (wt %)

| | Product 1 | Product 2 |
|---|---|---|
| Composition A | (inventive) | (comparison) |
| Tripolyphosphate | 10.0 | 17.5 |
| Sorbitol | 9.1 | 9.1 |
| Calcium lactate | 1.0 | 1.0 |
| Zinc acetate | 0.19 | 0.19 |
| Protease | 3.0 | 3.0 |
| Amylase | 1.5 | 1.5 |
| Fatty alcohol (EO)₂₂ 2-hydroxyalkyl ether | 4.0 | 4.0 |
| Acrylic acid sulfopolymer (Na salt) | 6.0 | 0.0 |
| Phosphonate | 0.0 | 1.8 |
| Boric acid | 3.0 | 3.0 |
| Potassium hydroxide | 4.3 | 4.3 |
| Crosslinked acrylic acid copolymer thickener | 0.83 | 0.85 |
| Preservative | 0.15 | 0.15 |
| Water | to 100 | to 100 |
| pH (undiluted) | 7.5 | 7.5 |
| Density (g/ml) | 1.22 | 1.26 |

TABLE 2
Composition B (wt %)

| | Product 1 | Product 2 |
|---|---|---|
| Composition B | (inventive) | (comparison) |
| Tripolyphosphate | 17.5 | 10.0 |
| Amphoteric polymer | 1.0 | 1.0 |
| Acrylic acid sulfopolymer (Na salt) | 0.0 | 6.0 |
| Phosphonate | 4.8 | 3.0 |
| Potassium hydroxide | 3.2 | 3.2 |
| Sodium carbonate | 10.0 | 10.0 |
| Monoethanolamine | 3.0 | 3.0 |
| Crosslinked acrylic acid copolymer thickener | 0.92 | 0.88 |
| Water | to 100 | to 100 |
| pH (undiluted) | 11.2 | 11.2 |
| Density (g/ml) | 1.36 | 1.28 |

The density difference between compositions A and B in the inventive product 1 was 11.5%, proceeding from the lower density of composition A, while the density difference between composition A and composition B in the comparison product 2, proceeding from the lower density of composition A, was only 1.6%.

TABLE 3
Cleaning results for various amylase-sensitive stains

| | Ground | | | Starch |
|---|---|---|---|---|
| | meat | Egg yolk | Oatmeal | mix |
| Product 1: just dispensed | 9.1 | 3.7 | 7.8 | 7.7 |
| Product 1: 18 hr incubation | 9.0 | 3.4 | 7.5 | 7.4 |
| Product 2: just dispensed | 9.1 | 3.7 | 7.8 | 7.7 |
| Product 2: 18 hr incubation | 9 | 3.4 | 6.5 | 5.1 |

Whereas with the comparison product 2 a significant appreciable loss of performance on the “oatmeal” and “starch mix” stains was observable after an incubation time of only 18 hours, no such performance loss was evident for the inventive product 1.

On protease-sensitive stains as well, performance losses that were recorded for the comparison product 2 did not occur with the inventive product 1.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A combination product comprising a packaging means and at least two flowable washing or cleaning compositions A and B separated from one another and present in said packaging means, wherein the compositions A and B contain
A: 10 to 75 wt % builder(s);
0.1 to 10 wt % enzyme preparation;
24.9 to 89.9 wt % water, and
B: 10 to 75 wt % builder(s);
less than 0.1 wt % enzyme preparation;
more than 24.9 wt % to 90 wt % water,
wherein the two compositions A and B have a density difference of at least 2%, based on the lower density.

2. The combination product according to claim 1, wherein the packaging means represents a water-insoluble two- or multi-chamber container, wherein each of the receiving chambers of the packaging means is provided with a spout.

3. The combination product according to claim 1, wherein the density difference, based on the lower density, is 5% to 60%.

4. The combination product according to claim 1, wherein the enzyme preparation in composition A contains amylase.

5. The combination product according to claim 1, wherein composition A has a lower density than composition B.

6. The combination product according to claim 1, wherein composition A contains 1 to 10 wt % sulfopolymer, wherein in particular the weight proportion of sulfopolymer in composition A based on composition A is higher than the weight proportion of sulfopolymer in composition B based on composition B.

7. An automatic washing or cleaning agent method, wherein from a combination product according to claim 1, the washing or cleaning compositions A and B are metered into a metering apparatus provided in a washing machine or into a separate metering apparatus, or directly into the washing machine, and a washing or cleaning operation is then initiated.
